(19) United States
(12) Patent Application Publication
(10) Pub. No.: US 2018/0343924 A1
(43) Pub. Date: Dec. 6, 2018

(54) ELECTRONIC CIGARETTE

(71) Applicant: Microjet Technology Co., Ltd., Hsinchu (TW)

(72) Inventors: Ching-Sung LIN, Hsinchu (TW); Chih-Kai CHEN, Hsinchu (TW); Shih-Chang CHEN, Hsinchu (TW); Li-Pang MO, Hsinchu (TW); Hsuan-Kai CHEN, Hsinchu (TW); Yung-Lung HAN, Hsinchu (TW); Chi-Feng HUANG, Hsinchu (TW)

(73) Assignee: Microjet Technology Co., Ltd., Hsinchu (TW)

(21) Appl. No.: 15/988,809

(22) Filed: May 24, 2018

(30) Foreign Application Priority Data
May 31, 2017 (TW) 106117784

(51) Int. Cl. A24F 47/00; A24F 7/04; H05B 1/02; F16K 31/00

(52) U.S. Cl. CPC A24F 47/008; F16K 31/004; H05B 1/0297; A24F 7/04

(57) ABSTRACT

An electronic cigarette includes a casing, a mouthpiece, a sensing unit, an atomizing member, a liquid storage member, a fluid transportation device and a power supply device. When the sensing unit senses an airflow, the sensing unit transmits an enabling signal to the power supply device and the power supply device accordingly controls the fluid transportation device to operate. The fluid transportation device guides the cigarette liquid out from the liquid storage member through an intake passage and transfers the cigarette liquid to a liquid conduit of the atomizing member through an outtake passage. The cigarette liquid transferred to the liquid conduit infiltrates out the through holes so as to be transferred to the electric heater of the atomizing member at a fixed amount. Consequently, an atomized vapor is generated and the user can inhale the atomized vapor through the opening of the mouthpiece.

### FIELD OF THE INVENTION

The present disclosure relates to an electronic cigarette, and more particularly to an electronic cigarette with a miniature fluid transportation device.

### BACKGROUND OF THE INVENTION

Nowadays, electronic cigarettes are widely used to replace the conventional tobacco cigarettes. FIG. 1A is a schematic cross-sectional view illustrating a conventional electronic cigarette. FIG. 1B is a partial enlargement of the conventional electronic cigarette. As shown in FIGS. 1A and 1B, the electronic cigarette comprises a casing 1 and the components which are assembled together and disposed within the casing 1, wherein the components include a power supply device 2, a sensing unit 3, an atomizing member 4 and a liquid storage member 5. The casing 1 is an assembly of a first casing 1a and a second casing 1b. The casing 1 may be a thin-wall metal pipe, e.g., stainless steel pipe. The length and diameter of the casing 1 are similar to those of the conventional tobacco cigarettes.

The power supply device 2 and the sensing unit 3 are disposed within the first casing 1a, while the first casing 1a has at least one air intake 1c adjacent to the sensing unit 3. The atomizing member 4 and the liquid storage member 5 are disposed within the second casing 1b. The atomizing member 4 is fixed on a bracket 7 and supported thereby. The atomizing member 4 comprises an electric heater 41 having a hollow structure, a liquid receiving part 42 sleeved on the electric heater 41, and a liquid transfer part 43 tightly holding the liquid receiving part 42. The liquid storage member 5 is also disposed within the second casing 1b. The liquid storage member 5 includes a passageway 51 for allowing gas to pass therethrough, and a liquid container 52 surrounding the passageway 51. Since the communication part 431 of the liquid transfer part 43 is contacted with the liquid container 52, the cigarette liquid in the liquid container 52 can be absorbed to or infiltrate to the liquid receiving part 42 through the communication part 431 of the liquid transfer part 43.

Moreover, a connection element 10 is arranged between the atomizing member 4 and the sensing unit 3 to establish air communication therebetween. Therefore, an airflow path from the air intake 1c to the passageway 51 is formed. The gas introduced into the air intake 1c can move along the airflow path, passing through the sensing unit 3, the connection element 10 and the electric heater 41, then being introduced into the passageway 51 of the liquid storage member 5. The connection element 10 is operable to achieve the electrical connection and air communication. In addition, the electronic cigarette further comprises an electrode ring 8. The electrode ring 8 is electrically connected with two pins (not shown) of the electric heater 41. Moreover, the electrode ring 8 is electrically connected with the power supply device 2 and the sensing unit 3 through the connection element 10. The electric circuit of the power supply device 2 is selectively enabled or disabled according to the result of sensing the airflow by the sensing unit 3. Moreover, a mouthpiece 9 is disposed on an end of the second casing 1b and in communication with the passageway 51 of the liquid storage member 5.

The operations of the electronic cigarette will be described as follows. As mentioned above, the cigarette liquid in the liquid container 52 can be absorbed to or infiltrate to the liquid receiving part 42 through the communication part 431 of the liquid transfer part 43. When the user inhales through the mouthpiece 9, the ambient air is sucked into the air intake 1c and forms an airflow inside the electronic cigarette. According to detection of the airflow by the sensing unit 3, the electric circuit of the electronic cigarette is enabled, so that the power supply device 2 provides electric power to the electrode ring 8 to activate the electric heater 41. Consequently, the cigarette liquid which is absorbed to or infiltrating to the liquid receiving part 42 is heated and atomized by the electric heater 41, and the user can inhale the atomized vapor through the mouthpiece 9. When the user stops inhaling, the sensing unit 3 senses the stop of the airflow and disables the electric circuit of the electronic cigarette to stop the electric heater 41 from heating the cigarette liquid.

As mentioned above, the cigarette liquid is transferred to the liquid receiving part 42 through the communication part 431 of the liquid transfer part 43. However, this design has some drawbacks. Since it is difficult to precisely control the amount of the cigarette liquid being transferred to the liquid receiving part 42, the cigarette liquid usually fails to be transferred uniformly to the liquid receiving part 42. If a part of the liquid receiving part 42 receives a lesser amount of the cigarette liquid than the other parts, the liquid droplets are not uniformly generated so that an unpleasing burning taste appears in the atomized vapor.

In addition, since the amount of the cigarette liquid being transferred to the liquid receiving part 42 cannot be precisely controlled, the liquid leakage occurs. Especially when the electronic cigarette stays in an upright position with the mouthpiece 9 on the top, the cigarette liquid continuously moves from the liquid container 52 to the liquid receiving part 42 under the force of gravity. Once the liquid receiving part 42 reaches a saturation state, the excessive cigarette liquid drops down to the bracket 7 and the connection element 10. Moreover, the cigarette liquid may drop down through the sensing unit 3 and leak out from the at least one air intake 1c, which results in terrible user experience.

Moreover, there are some differences between the electronic cigarettes and the tobacco cigarettes. When people smoke the tobacco cigarettes, they usually gulp air quickly and shortly, whereas people can only smoke the electronic cigarettes in the slowly and gently way. Such difference is resulted from the great amount of oxygen inhaled by the user that can speed up burning tobacco, so that the user can quickly get the wanted amount of smoke. However, while the user smokes the conventional electronic cigarette, the electric power transmitted to the electric heater cannot be adjusted. That is, the heating speed of the electric heater cannot be adjusted. If the heating speed is too fast, the cigarette liquid is atomized by the atomizing member very quickly. Since the cigarette liquid of the conventional electronic cigarette is provided according to a siphon effect, the speed of providing the cigarette liquid is too slow to fit the speed of atomization. Under this circumstance, the amount of the atomized vapor is insufficient or the atomizing member is burnt out. Since the electric power transmitted to the atomizing member of the conventional electronic cigarette is fixed, the user has to smoke the electronic cigarette slowly and gently to provide sufficient heating time to the atomizing member. That is, the conventional method of atomizing the cigarette liquid of the electronic cigarette still has some drawbacks. The above problems lead to significant differences between the tobacco cigarette and the electronic cigarette. Because of these drawbacks, the user does not prefer to choose the electronic cigarette for replacing the tobacco cigarette.

For solving the drawbacks of the conventional technologies, the present disclosure provides an improved electronic cigarette.

### SUMMARY OF THE INVENTION

An object of the present disclosure provides an electronic cigarette. The cooperation of a fluid transportation device and a liquid conduit of an atomizing member forms a controllable switch element. The amount of the cigarette liquid to be transferred to the atomizing member is precisely controlled by the controllable switch element. Consequently, the taste of the atomized vapor is enhanced, and the cigarette liquid leakage problem is solved.

Another object of the present disclosure provides an electronic cigarette for allowing the user to inhale a great amount of atomized vapor in a short period of time. The electronic cigarette includes a sensing unit, which includes an airflow sensor and an air pressure sensor. The sensing unit is operable to generate and transmit an adjusting signal to a control module according to the result of detecting a pressure of the airflow. According to the adjusting signal, the control module adjusts the speed of atomizing the cigarette liquid and the speed of providing the cigarette liquid. That is, the control module adjusts the control signals transmitted from the control module to the fluid transportation device and the heater module according to the adjusting signal. Since the driving power of the heater module and the driving frequency of the fluid transportation device are correspondingly changed according to the control signals received from the control module, the speed of atomizing the cigarette liquid and the speed of providing the cigarette liquid are adjusted. Consequently, the user can inhale a great amount of atomized vapor quickly and inhale the same amount and concentration of atomized vapor in each breath.

In accordance with an aspect of the present disclosure, there is provided an electronic cigarette. The electronic cigarette includes a casing, a mouthpiece, a sensing unit, an atomizing member, a liquid storage member, a fluid transportation device and a power supply device. The casing includes an air intake. The mouthpiece closes an end of the casing and includes an opening. The sensing unit is disposed within the casing and in communication with the mouthpiece. The electronic cigarette is selectively enabled or disabled according to a result of detecting an airflow by the sensing unit. The atomizing member is disposed within the casing, vertical to an inner wall of the casing and adjacent to the sensing unit. The atomizing member comprises an electric heater and a liquid conduit. The electric heater is sleeved on the liquid conduit, and the liquid conduit comprises an inlet at an end thereof and plural through holes thereon. The liquid storage member is disposed within the casing and used for storing a cigarette liquid. The fluid transportation device is disposed within the casing and disposed under the liquid storage member. The fluid transportation device comprises an intake passage and an outtake passage. The intake passage is in communication with the liquid storage member, and the outtake passage is in communication with the inlet of the liquid conduit of the atomizing member. The power supply device is electrically connected with the sensing unit, the atomizing member and the fluid transportation device. The power supply device is used for providing driving power and a control signal. The sensing unit sends an enabling signal to the power supply device according to detection of the airflow. After receiving the enabling signal, the power supply device controls the fluid transportation device to operate, guiding the cigarette liquid out from the liquid storage member through the intake passage, and transferring the cigarette liquid to the liquid conduit through the outtake passage of the fluid transportation device and a liquid intake pipe. The cigarette liquid infiltrates out of the liquid conduit through the plural through holes, so that the cigarette liquid is transferred to the electric heater of the atomizing member at a fixed amount. After the cigarette liquid is heated by the electric heater, an atomized vapor is generated. The user can inhale the atomized vapor through the opening of the mouthpiece. On the other hand, the sensing unit stops sending the enabling signal to the power supply device according to the result of detecting a stop of the airflow. As a result, the fluid transportation device is disabled by the power supply device. Consequently, the fluid transportation device stops transferring the cigarette liquid, and the electronic cigarette stops operating.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A is a schematic cross-sectional view illustrating the conventional electronic cigarette;

FIG. 1B is a partial enlargement of the conventional electronic cigarette in FIG. 1A;

FIG. 2A is a schematic cross-sectional view illustrating an electronic cigarette according to an embodiment of the present disclosure;

FIG. 2B is a partial enlargement of the electronic cigarette in FIG. 2A;

FIG. 2C is a schematic top view illustrating some components of the atomizing member of the electronic cigarette according to the embodiment of the present disclosure;

FIG. 3 is a schematic functional block diagram illustrating the power supply device of the electronic cigarette according to the embodiment of the present disclosure;

FIG. 4 is a schematic view illustrating the fluid transportation device of the electronic cigarette according to the embodiment of the present disclosure;

FIG. 5A is a schematic exploded view illustrating the fluid transportation device of FIG. 4 and taken along a front side;

FIG. 5B is a schematic exploded view illustrating the fluid transportation device of FIG. 4 and taken along a rear side;

FIG. 6A is a schematic view illustrating the valve body of the fluid transportation device of FIG. 4 and taken along the front side;

FIG. 6B is a schematic view illustrating the valve body of the fluid transportation device of FIG. 4 and taken along the rear side;

FIG. 7A is a schematic view illustrating the valve chamber seat of the fluid transportation device of FIG. 4 and taken along the front side;

FIG. 7B is a schematic view illustrating the valve chamber seat of the fluid transportation device of FIG. 4 and taken along the rear side;

FIG. 8 is a schematic view illustrating the valve membrane of the fluid transportation device of FIG. 4;

FIG. 9 is a schematic perspective view illustrating the outer sleeve of the fluid transportation device of FIG. 4;

FIG. 10A is a schematic view illustrating the valve cover of the fluid transportation device of FIG. 4 and taken along the front side;

FIG. 10B is a schematic view illustrating the valve cover of the fluid transportation device of FIG. 4 and taken along the rear side;

FIG. 11 is a schematic cross-sectional view illustrating the assembled structure of the fluid transportation device of FIG. 4;

FIG. 12A is a schematic view illustrating the operations of the fluid transportation device in a first situation; and

FIG. 12B is a schematic view illustrating the operations of the fluid transportation device in a second situation.

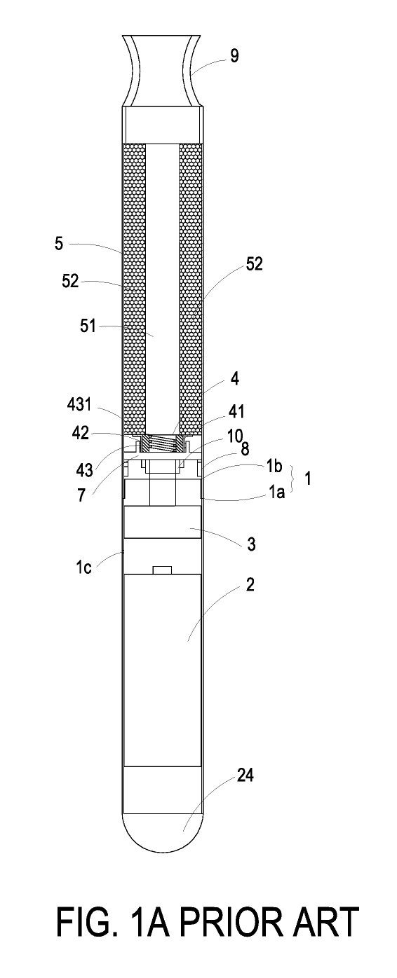

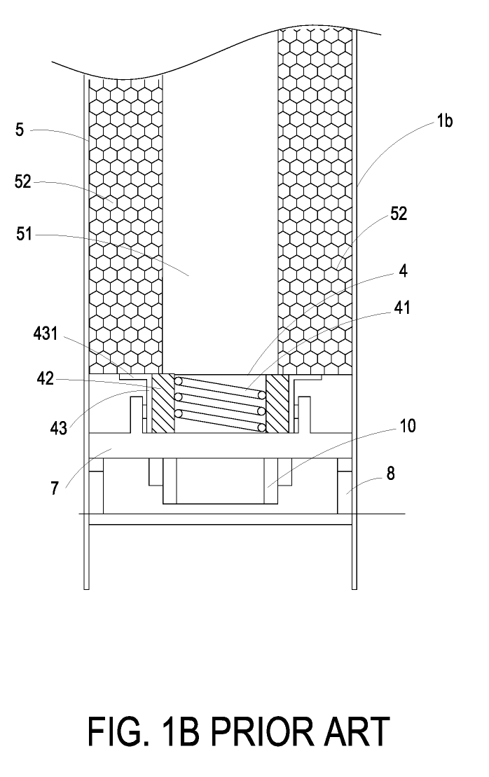

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

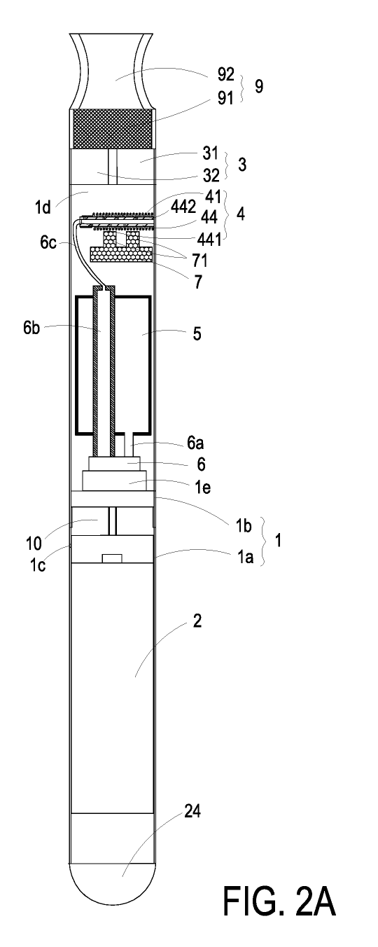

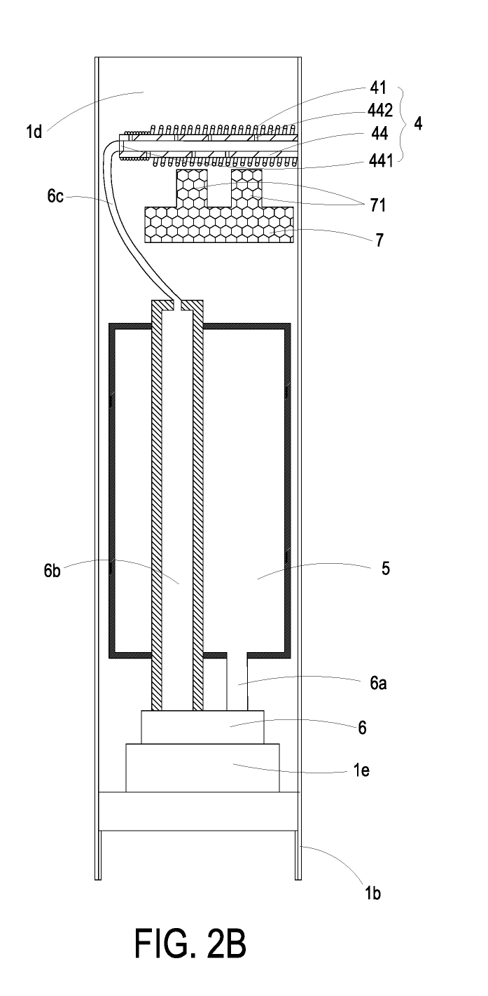

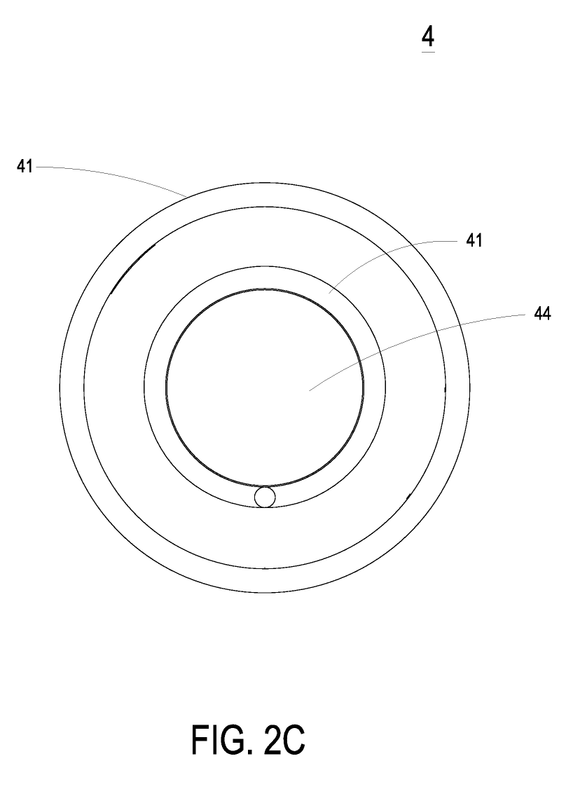

Please refer to FIG. 2A. FIG. 2A is a schematic cross-sectional view illustrating an electronic cigarette according to an embodiment of the present disclosure. The electronic cigarette of the present disclosure comprises a casing 1, a power supply device 2, a sensing unit 3, an atomizing member 4, a liquid storage member 5, a fluid transportation device 6, a bracket 7 and a mouthpiece 9. The casing 1 is an assembly of a first casing 1a and a second casing 1b, which are oppositely connected to each other. The power supply device 2 and a connection element 10 are disposed within the first casing 1a, wherein the connection element 10 is used for establishing electrical connection or air communication. The second casing 1b comprises an airflow chamber 1d. The sensing unit 3, the atomizing member 4, the liquid storage member 5, the fluid transportation device 6 and the bracket 7 are disposed within the second casing 1b. The power supply device 2 is detachably disposed within the first casing 1a, so that the power supply device 2 can be easily taken apart for fixing or replacement. By the connection element 10, the first casing 1a and the second casing 1b are fixed and assembled with each other, and also electrically connected with each other. The first casing 1a and the second casing 1b may be thin-wall metal pipes, e.g., stainless steel pipes. After the casing 1 is assembled by the first casing 1a and the second casing 1b, the length and diameter of the casing 1 are similar to those of the conventional tobacco cigarettes. The first casing 1a comprises at least one air intake 1c adjacent to the connection element 10, so that the ambient air can be introduced into the electronic cigarette through the air intake 1c. The air intake 1c, the airflow chamber 1d, the sensing unit 3 and the mouthpiece 9 define an airflow path. In some embodiments, the air intake 1c is disposed on the outer wall of the airflow chamber 1d to be in air communication therewith. Consequently, an atomized vapor can be guided out from the second casing 1b sequentially through the airflow chamber 1d, the sensing unit 3 and the mouthpiece 9 and finally inhaled by the user through the mouthpiece 9.

Please refer to FIGS. 2A, 2B and 2C. FIG. 2B is a partial enlargement of the electronic cigarette in FIG. 2A. FIG. 2C is a schematic top view illustrating some components of the atomizing member of the electronic cigarette according to the embodiment of the present disclosure. In the embodiment, the mouthpiece 9 closes an end of the second casing 1b. The sensing unit 3 is disposed within the second casing 1b, adjacent to the mouthpiece 9 and in communication with the mouthpiece 9. The sensing unit 3 is operable to detect an airflow, and the electronic cigarette is selectively enabled or disabled according to detection of the airflow by the sensing unit 3. The atomizing member 4 is disposed within the second casing 1b, vertical to the inner wall of the second casing 1b, and adjacent to the sensing unit 3. In the embodiment, the sensing unit 3 includes but not limited to an airflow sensor 31 and an air pressure sensor 32. The airflow sensor 31 transmits an enabling signal to the power supply device 2 according to detection of the airflow. Consequently, the electric circuit of the power supply device 2 is selectively enabled or disabled. The air pressure sensor 32 is capable of changing a speed of providing the cigarette liquid and a speed of atomizing the cigarette liquid, according to the result of monitoring the magnitude of the pressure of the airflow. That is, in accordance with the magnitude of the pressure of the airflow which is related to the magnitude of inhalation by the user, the air pressure sensor 32 adjusts an adjusting signal which is transmitted from the air pressure sensor 32 to the power supply device 2. As a result, the control signals provided from the power supply device 2 are accordingly adjusted, so as to change a driving frequency of the fluid transportation device 6 to adjust the speed of providing the cigarette liquid, and to change the driving power of the heater module 4 to adjust the speed of atomizing the cigarette liquid.

In the embodiment, the atomizing member 4 is disposed within the second casing 1b, vertical to the inner wall of the second casing 1b and adjacent to the sensing unit 3. The atomizing member 4 comprises an electric heater 41 and a liquid conduit 44. The electric heater 41 defines a hollow part, and the electric heater 41 has two pins (not shown) electrically connected with the power supply device 2 through the connection element 10. According to a state of the airflow detected by the sensing unit 3, the electric heater 41 is controlled to selectively start or stop heating. The liquid conduit 44 is a tubular structure for transporting liquid and may be made of a stainless steel material or a heat-resistant material. The liquid conduit 44 comprises an inlet 441 at an end opposing to the end disposed on the inner wall of the second casing 1b, and plural through holes 442 disposed on the sidewall of the liquid conduit 44. The electric heater 41 is sleeved on the liquid conduit 44 and is configured to atomize the cigarette liquid, thereby generating the atomized vapor for being inhalation by the user.

In the embodiment, the bracket 7 is disposed within the second casing 1b and in connection with the inner wall of the second casing 1b. The bracket 7 comprises two protrusions 71, which are in connection with the atomizing member 4 to fix the atomizing member 4 thereon and support it, but not limited thereto. By using the protrusions 71 of the bracket 7 to support the atomizer 4, the contact area between the atomizing member 4 and the bracket 7 is reduced, and the exposed area of the electric heater 41 is increased, so that the efficiency of atomizing the cigarette liquid is improved.

In the embodiment, the liquid storage member 5 is disposed within the second casing 1b and configured to store the cigarette liquid. The fluid transportation device 6 is also disposed within the second casing 1b and disposed under the liquid storage member 5. The fluid transportation device 6 comprises an intake passage 6a, an outtake passage 6b and a liquid intake pipe 6c. The intake passage 6a is in communication with the liquid storage member 5. The outtake passage 6b passes through the liquid storage member 5 and is in communication with the inlet 441 of the liquid conduit 44 of the atomizing member 4 through the liquid intake pipe 6c. In the embodiment, the liquid inputting pipe 6c is a high heat-resistance soft pipe. By using the liquid intake pipe 6c to connect the outtake passage 6b and the inlet 441 of the liquid conduit 44, the fluid transportation device 6 is directly in communication with the atomizing member 4, so as to avoid being obstructed by the bracket 7 in the airflow chamber 1d. Additionally, the softy of the liquid intake pipe 6c makes the replacing operation more convenient. The fluid transportation device 6 is served as a valve switch element for transporting the cigarette liquid in the liquid storage member 5. The fluid transportation device 6 is supported by a supporting seat 1e to be positioned and fixed in the second casing 1b.

In the embodiment, when the sensing unit 3 detects the airflow, the sensing unit 3 sends an enabling signal to the power supply device 2, and the power supply device 2 accordingly enables the fluid transportation device 6. Consequently, the cigarette liquid in the liquid storage member 5 is guided out through the intake passage 6a, being transferred to the liquid conduit 44 of the atomizing member 4 by the outtake passage 6b and the liquid intake pipe 6c, sequentially. Then, the cigarette liquid infiltrates out of the liquid conduit 44 through the plural through holes 442. Consequently, the cigarette liquid is transferred to the electric heater 41 of the atomizing member 4 at a fixed amount, and is heated by the electric heater 41 to generate an atomized vapor. While the user is inhaling the atomized vapor through the opening 92 of the mouthpiece 9, the ambient air is introduced by the air intake 1c and guided to the airflow path of the electric cigarette, so that the pressure between the interior and the exterior of the casing 1 is balanced. On the contrary, when the sensing unit 3 detects a stop of the airflow, the sensing unit 3 stops sending the enabling signal to the power supply device 2. Consequently, the fluid transportation device 6 stops transferring the cigarette liquid, and the electronic cigarette stops operating. As mentioned above, by transporting a fixed amount of the cigarette liquid to the atomizing member 4, the user is able to not only inhale a great amount of atomized vapor in a small period of time but also inhale the atomized vapor in a consistent amount and consistent concentration in each breath.

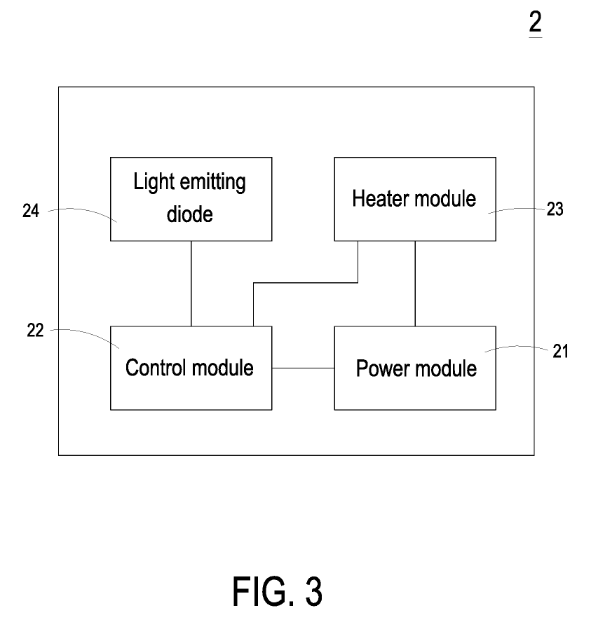

As shown in FIG. 2 to FIG. 3, in which FIG. 3 is schematic functional block diagram illustrating the power supply device of the electronic cigarette according to the embodiment of the present disclosure. The power supply device 2 is electrically connected with the sensing unit 3, the atomizing member 4 and the fluid transportation device 6 to provide driving power and at least one control signal for them. In the embodiment, the power supply device 2 comprises a power module 21, a control module 22, a heater module 23 and a light emitting diode 24. The power module 21 may be a rechargeable battery or a disposable battery for providing driving power to the control module 22, the heater module 23 and the sensing unit 3. The control module 22 is operable to transmit a first control signal to the heater module 23 and a second control signal to the fluid transportation device 6. Moreover, the control module 22 is configured to provide driving power to the fluid transportation device 6. The heater module 23 provides electric energy to the atomizing member 4 for implementing heating and atomization. The light emitting diode 24 is disposed on an end of the first casing 1a opposing to another end connected to the second casing 1b. Under control of the control module 22, the light emitting diode 24 is turned on or turned off to provide a prompt signal to indicate the operating condition of the electronic cigarette or to indicate an inhalation intensity of the atomized vapor.

As shown in FIGS. 2A, the mouthpiece 9 is disposed on an end of the second casing 1b opposing to another end connected to the first casing 1a and in communication with the airflow chamber 1d. The mouthpiece 9 comprises a filter 91 and an opening 92. The filter 91 is located at the end of the second casing 1b and closing a junction of the mouthpiece 9 and the casing 1. Therefore, the cigarette liquid which is incompletely atomized is blocked from entering the opening 92 by the filter 91. Consequently, the cigarette liquid will not be inhaled by the user.

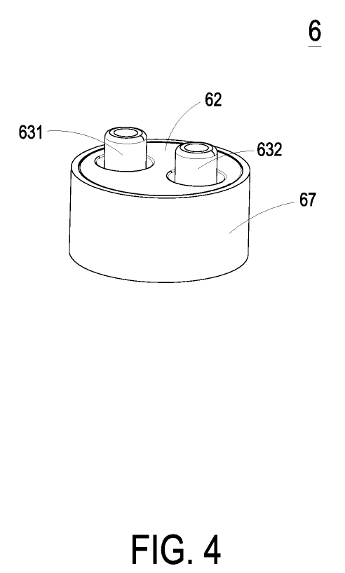

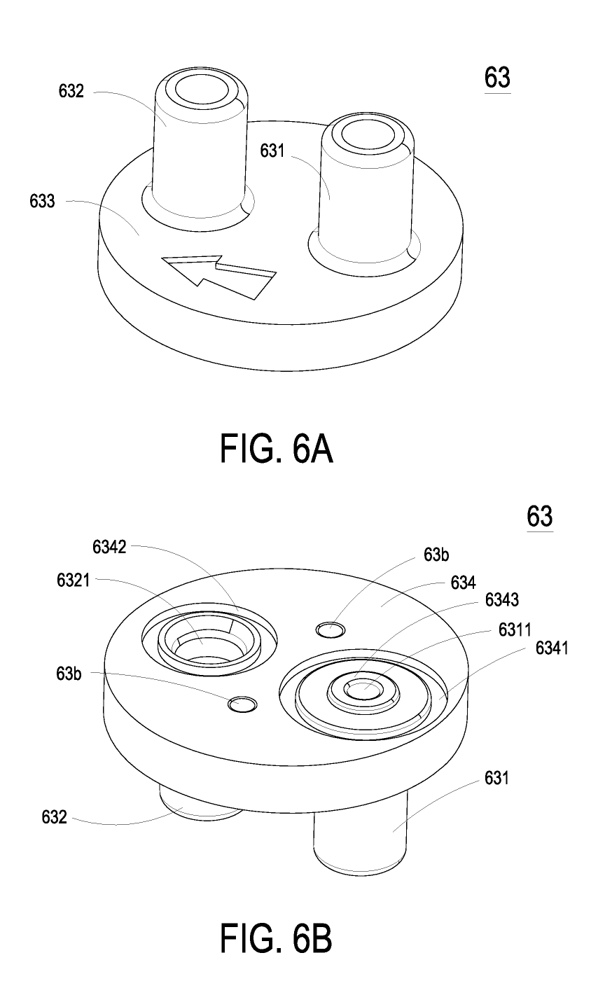

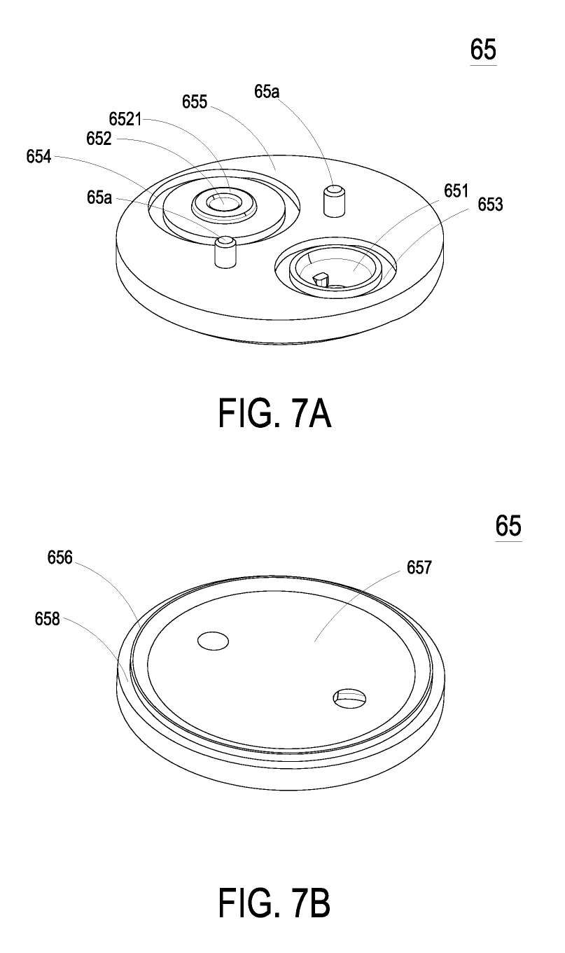

The fluid transportation device 6 according to one embodiment of the present disclosure is exemplified below. Please refer to FIGS. 4, 5A, 5B, 6A, 6B, 7A and 7B. The valve body 63 and the valve chamber seat 65 are the main components guiding the cigarette liquid in and out from the fluid transportation device 6. The valve body 63 comprises an inlet passage 631 and an outlet passage 632. The inlet passage 631 and the outlet passage 632 run through a first surface 633 and a second surface 634 of the valve body 63. An inlet opening 6311 is formed on the second surface 634 and in communication with the inlet passage 631. Moreover, a groove 6341 is formed in the second surface 634 and arranged around the inlet opening 6311. A protrusion block 6343 is disposed on the periphery of the inlet opening 6311. An outlet opening 6321 is formed on the second surface 634 and in communication with the outlet passage 632. A groove 6342 is arranged around the outlet opening 6321. Moreover, plural recesses 63b are formed on the second surface 634 of the valve body 63.

The fluid transportation device 6 comprises a valve body 63, a valve membrane 64, a valve chamber seat 65, an actuator 66 and an outer sleeve 67. After the valve body 63, the valve membrane 64, the valve chamber seat 65 and the actuator 66 are sequentially stacked on each other, the combination of the valve body 63, the valve membrane 64, the valve chamber seat 65 and the actuator 66 is accommodated within the outer sleeve 67 and assembled with the outer sleeve 67.

The valve chamber seat 65 has plural posts 65a disposed on a third surface 655 thereof for being engaged with corresponding recesses 63b of the valve body 63 to make the valve body 63 and the valve chamber seat 65 assembled with each other. The valve chamber seat 65 includes an inlet valve channel 651 and an outlet valve channel 652 running through the third surface 655 and a fourth surface 656. A groove 653 is formed on the third surface 655 and arranged around the inlet valve channel 651. A protrusion block 6521 is disposed on the periphery of the outlet valve channel 652. A groove 654 is formed in the third surface 655 and arranged around the outlet valve channel 652. The valve chamber seat 65 further has a pressure chamber 657 concavely formed on the fourth surface 656. The pressure chamber 657 is in communication with the inlet valve channel 651 and the outlet valve channel 652. Moreover, a concave structure 658 is formed on the fourth surface 656 and arranged around the edge of the pressure chamber 657.

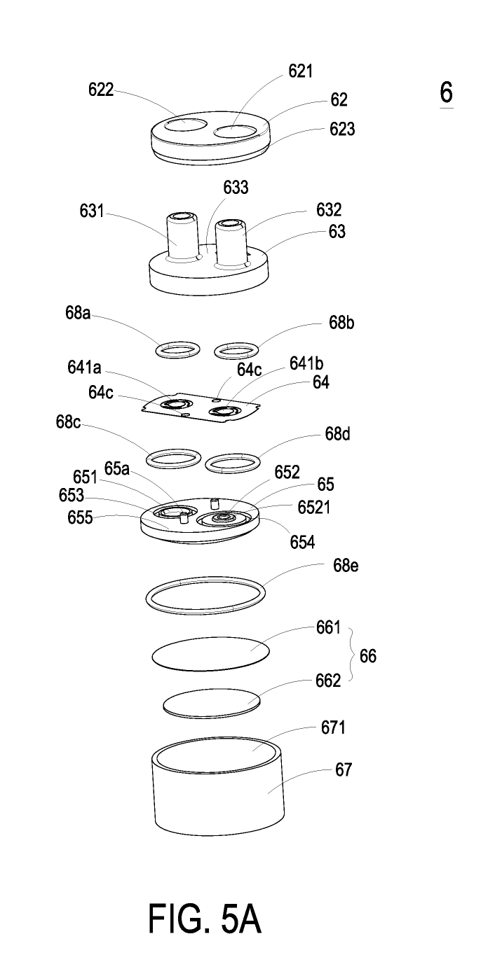

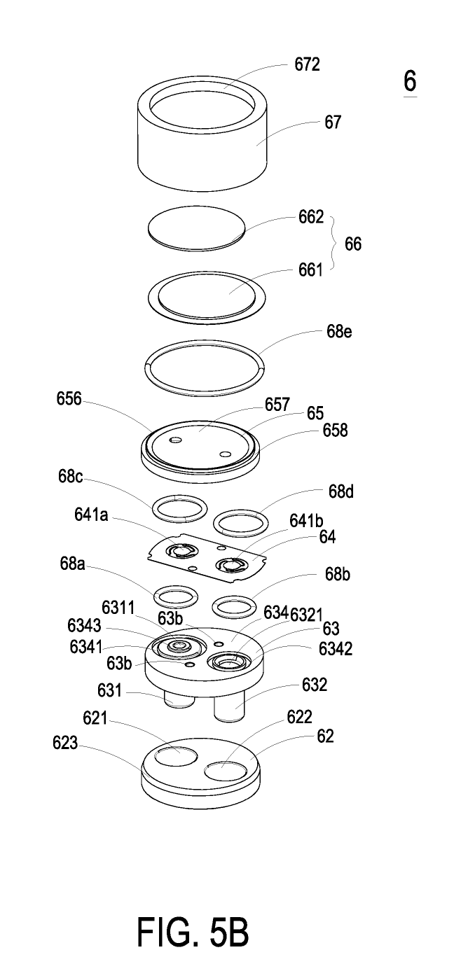

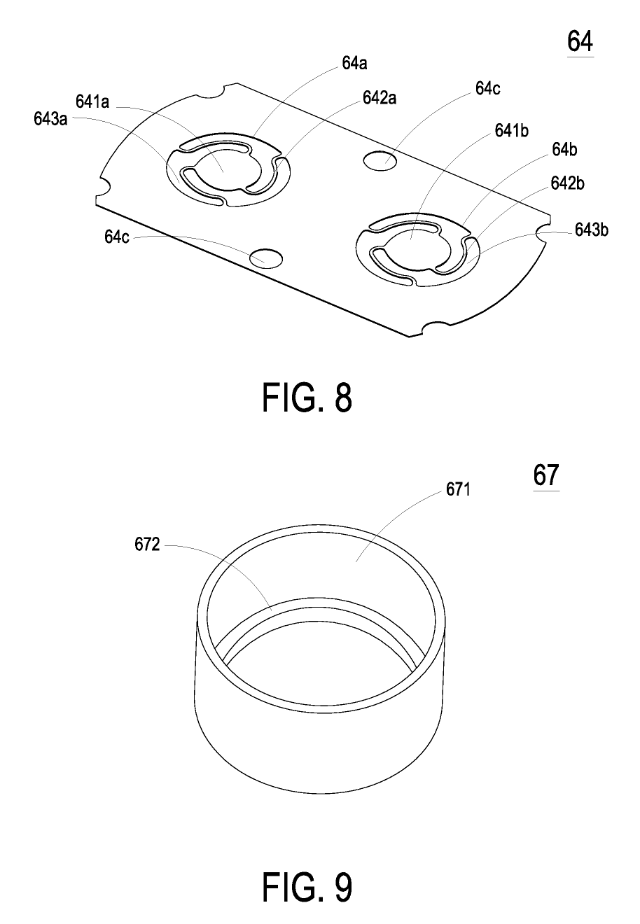

Please refer to FIGS. 5A, 5B and 8. In an embodiment, the valve membrane 64 is made of polyimide (PI), and the valve membrane 64 is produced by a reactive ion etching (RIE) process, in which a photosensitive photoresist is applied to a pattern of the valve structure on the polyimide layer, and then the polyimide layer is exposed to light to make the polyimide layer uncovered by the photoresist etched so that the valve structure of the valve membrane 64 is formed. The valve membrane 64 is a flat thin film structure. As shown in FIG. 8, the valve membrane 64 comprises two valve plates 641a and 641b at two perforated regions 64a and 64b, respectively. The two valve plates 641a and 641b have the same thickness. The valve membrane 64 further comprises plural extension parts 642a and 642b. The extension parts 642a and 642b are arranged around the valve plates 641a and 641b for elastically supporting the valve plates 641a and 641b. The valve membrane 64 further comprises plural hollow parts 643a and 643b, each of which is formed between two adjacent extension parts 642a and 642b. Any one of the valve plates 41a and 41b to which an external force is exerted is stretched out to a certain magnitude of displacement since it is elastically supported by the extension parts 42a and 42b, by which a valve structure is formed. Preferably but not exclusively, the valve plates 641a and 641b have circular shapes, rectangular shapes, square shapes or arbitrary shapes. The valve membrane 64 further comprises plural positioning holes 64c for being penetrated by the posts 65a of the valve chamber seat 65. Consequently, the valve membrane 64 is positioned on the valve chamber seat 65. Meanwhile, the inlet valve channel 651 and the outlet valve channel 652 are respectively covered by the valve plates 641a and 641b (see FIG. 8).

In this embodiment, the valve chamber seat 65 comprises two posts 65a, and valve membrane 64 comprises two positioning holes 64c. It is noted that the number of the posts 65a and the number of the positioning holes 64c are not restricted.

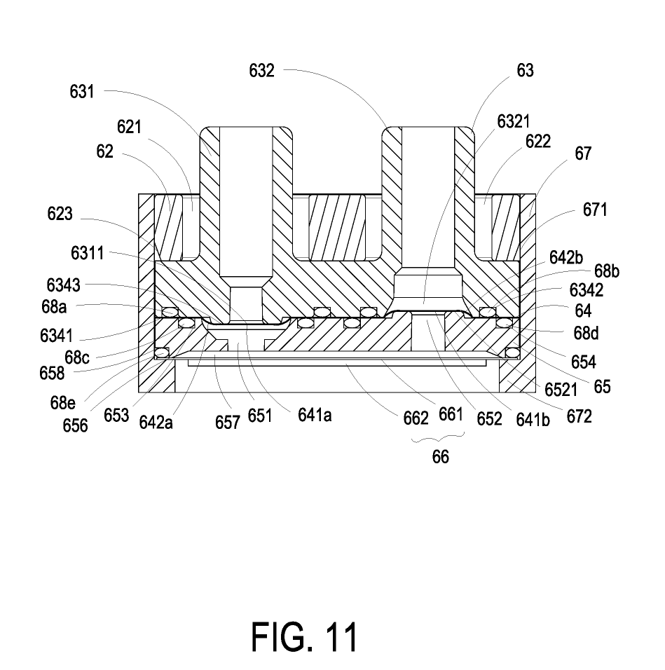

Please refer to FIG. 11. When the valve body 63 and the valve chamber seat 65 are combined together, four sealing rings 68a, 68b, 68c and 68d are trapped in the groove 6341 of the valve body 63, the groove 6342 of the valve body 63, the groove 653 of the valve chamber seat 65 and the groove 654 of the valve chamber seat 65, respectively. Due to the sealing rings 68a, 68b, 68c and 68d, the cigarette liquid is not leaked out after the valve body 63 and the valve chamber seat 65 are combined together. The inlet passage 631 of the valve body 63 is aligned with the inlet valve channel 651 of the valve chamber seat 65, in which the communication between the inlet passage 631 and the inlet valve channel 651 is selectively enabled or disabled through the valve plate 641a of the valve membrane 64. Similarly, the outlet passage 632 of the valve body 63 is aligned with the outlet valve channel 652 of the valve chamber seat 65, in which the communication between the outlet passage 632 and the outlet valve channel 652 is selectively enabled or disabled through the valve plate 641b of the valve membrane 64. When the valve plate 641a of the valve membrane 64 is opened, the cigarette liquid is transferred from the inlet passage 631 to the pressure chamber 657 through the inlet valve channel 651. When the valve plate 641b of the valve membrane 64 is opened, the cigarette liquid is transferred from the pressure chamber 657 to the outlet passage 632 through the outlet valve channel 652 and is discharged from the fluid transportation device 6.

Please refer to FIGS. 5A and 5B again. The actuator 66 is composed of a vibration plate 661 and a piezoelectric element 662. The piezoelectric element 662 is attached on a surface of the vibration plate 661. In an embodiment, the vibration plate 661 is made of a metallic material, and the piezoelectric element 662 is made of a highly-piezoelectric material such as lead zirconate titanate (PZT) piezoelectric powder. When a voltage is applied to the piezoelectric element 662, the piezoelectric element 662 is subjected to a deformation, making the vibration plate 661 vibrate along the vertical direction in the reciprocating manner to drive the operation of the fluid transportation device 6. In this embodiment, the vibration plate 661 of the actuator 66 is assembled with the fourth surface 656 of the valve chamber seat 65 to cover and seal the pressure chamber 657. As mentioned above, there is a concave structure 658 around the pressure chamber 657. For preventing fluid leakage, a sealing ring 68e is trapped in the concave structure 658.

As mentioned above, the valve body 63, the valve membrane 64, the valve chamber seat 65 and the actuator 66 are the main components of the fluid transportation device 6 that guide the cigarette liquid in and out. In some embodiments, in order to position and join these stacked components without using fastening elements (e.g., screws, nuts or bolts), the fluid transportation device 6 further includes a valve cover 62 and an outer sleeve 64. The valve body 63, the valve membrane 64, the valve chamber seat 65 and the actuator 66 are sequentially stacked and accommodated within the outer sleeve 67. Then, the valve cover 62 is introduced into the outer sleeve 67 from top to be tightly fitted with the inner wall of the outer sleeve 67. Consequently, the stacked components in the outer sleeve 7 are positioned, and the assembly of the fluid transportation device 6 is accomplished.

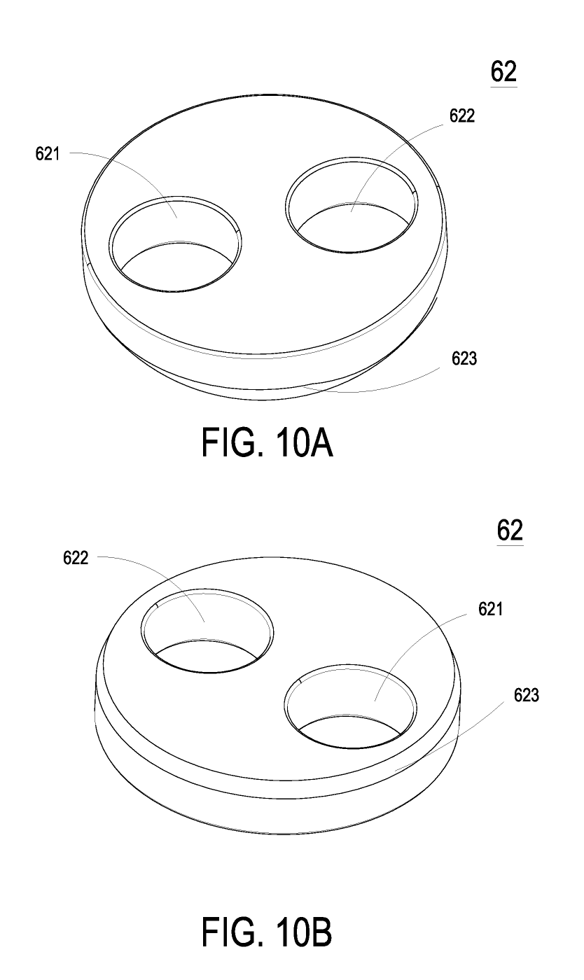

Please refer to FIGS. 5A, 5B and 9. The outer sleeve 67 is made of a metallic material. The outer sleeve 67 includes an inner wall 671 surrounding an accommodation space, and an annular protrusion structure 672 formed on the bottom of the inner wall 671 of the outer sleeve 67. Please refer to FIGS. 10A and 10B. The valve cover 62 is also made of a metallic material. The valve cover 62 has a first opening 621 and a second opening 622 for being penetrated by the inlet passage 631 and the outlet passage 632 of the valve body 63, respectively. Moreover, a bottom edge of the valve cover 62 has a chamfer 623. The outer diameter of the valve cover 62 is slightly larger than the inner diameter of the inner wall 671 of the outer sleeve 67.

Please refer to FIGS. 5A and 5B again. The valve body 63, the valve membrane 64, the valve chamber seat 65 and the actuator 66 which are sequentially stacked are placed into the accommodation space within the inner wall 671 of the outer sleeve 67, and the whole stacked structure is supported by the annular protrusion structure 672 of the outer sleeve 67. Then the valve cover 62 is smoothly introduced into the outer sleeve from top by the chamfer 623 and to be tightly fitted with the inner wall 671 of the outer sleeve 67, as the outer diameter of the valve cover 62 is slightly larger than the inner diameter of the inner wall 671 of the outer sleeve 67. Consequently, the valve cover 62 is assembled with the combination of the valve body 63, the valve membrane 64, the valve chamber seat 65 and the actuator 66 and all these components are securely fixed between the valve cover 62 and the outer sleeve 67, so as to accomplish assembly of the fluid transportation device 6. In this embodiment, the actuator 66 is also disposed within the accommodation space of the outer sleeve 67. When piezoelectric element 662 is subjected to a deformation in response to the applied voltage, the vibration plate 661 vibrates along the vertical direction in the reciprocating manner in which deformation and resonance occur. It is not necessary to use any fastening elements (e.g., screws, nuts or bolts) to fasten the components of the fluid transportation device 6.

Please refer to FIG. 11 again. The inlet valve channel 651 of the valve chamber seat 65 is aligned with the inlet opening 6311 of the valve body 63 as the valve plate 641a of the valve membrane 64 is disposed therebetween to act as a valve. When the valve plate 641a is closing the inlet opening 6311 of the valve body 63, the valve plate 641a is in close contact with the protrusion block 6343 of the valve body 63. Consequently, a pre-force is generated to result in a stronger sealing effect and backflow of the cigarette liquid is prevented. Similarly, the outlet valve channel 652 of the valve chamber seat 65 is aligned with the outlet opening 6321 of the valve body 63 as the valve plate 641b of the valve membrane 64 is disposed therebetween to act as a valve. When the valve plate 641b is closing the outlet valve channel 652 of the valve chamber seat 65, the valve plate 641b is in close contact with the protrusion block 6521 of the valve chamber seat 65. Consequently, a pre-force is generated to result in a stronger sealing effect, and the cigarette liquid will not return back to the pressure chamber 657. Under this circumstance, while the fluid transportation device 6 is not in action, the backflow of the cigarette liquid in the inlet passage 631 and the outlet passage 632 of the valve body 63 is prevented.

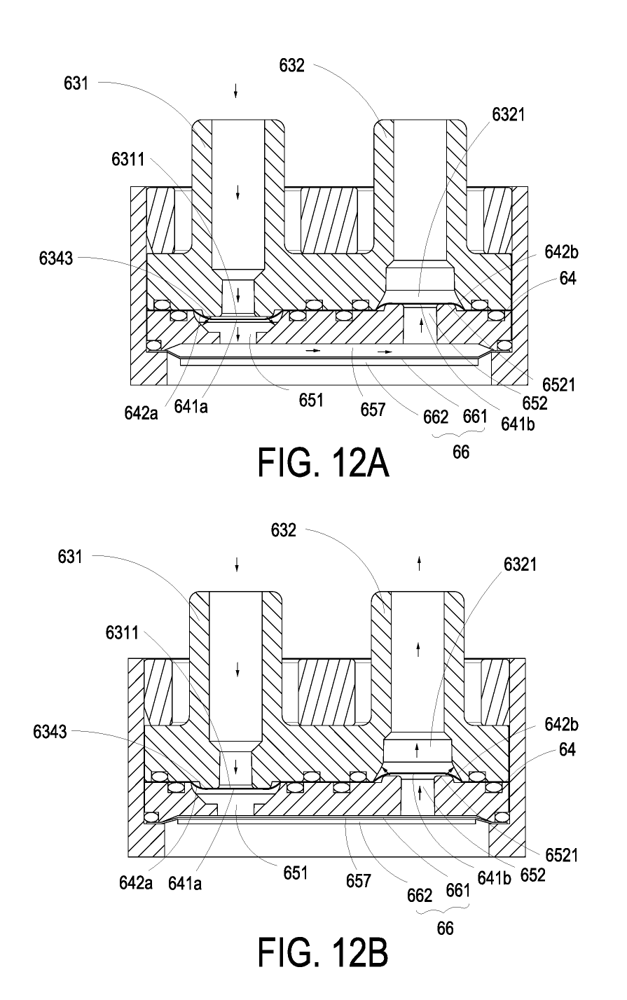

The operations of the fluid transportation device 6 will be described in more details as follows. FIG. 12A is a schematic view illustrating the operations of the fluid transportation device in a first situation. As shown in FIG. 12A, when the piezoelectric element 662 of the actuator 66 is subjected to a deformation in response to the applied voltage and causes downwardly deformation of the vibration plate 661, the volume of the pressure chamber 657 is expanded to result in a suction force. In response to the suction force, the valve plate 641a of the valve membrane 64 is quickly opened. Consequently, a great amount of the cigarette liquid is sucked into the inlet passage 631 of the valve body 63, transferred to the pressure chamber 657 through the inlet opening 6311 of the valve body 63, the hollow parts 643a (shown in FIG. 8) of the valve membrane 64 and the inlet valve channel 651 of the valve chamber seat 65. Then, the cigarette liquid is temporarily stored in the pressure chamber 657. Since the suction force is also exerted on the outlet valve channel 652, the valve plate 641b supported by the extension parts 642b of the valve membrane 64 is in close contact with the protrusion block 6521 of the valve chamber seat 65. Consequently, the valve plate 641b is tightly closed.

FIG. 12B is a schematic view illustrating the operations of the fluid transportation device in a second situation. As shown in FIG. 12B, once the direction of electric field applied to the piezoelectric element 662 is changed, the piezoelectric element 662 drives the vibration plate 661 to deform upwardly, and the volume of the pressure chamber 657 is shrunken. As a result, the cigarette liquid within the pressure chamber 657 is compressed, generating a pushing force applied to the inlet valve channel 651. In response to the pushing force, the valve plate 641a supported by the extension parts 642a of the valve membrane 64 is in close contact with the protrusion block 6343 of the valve body 63 to be closed. Consequently, the cigarette liquid is blocked from returning back to the inlet valve channel 651. Meanwhile, the pushing force is also applied to the outlet valve channel 652. In response to the pushing force, the valve plate 641b supported by the extension parts 642b of the valve membrane 64 is separated from the protrusion block 6521 to be open. Consequently, the cigarette liquid is transferred from the pressure chamber 657 to the exterior of the fluid transportation device 6 through the outlet valve channel 652 of the valve chamber seat 65, the hollow parts 643b (shown in FIG. 8) of the valve membrane 64, the outlet opening 6321 of the valve body 63 and the outlet passage 632 of the valve body 63, sequentially.

The processes of FIGS. 12A and 12B are repeatedly done. Consequently, the cigarette liquid can be transferred by the fluid transportation device 6 at high efficiency with no backflow.

The fluid transportation device 6 is disposed within the second casing 1b on the supporting seat 1e and under the liquid storage member 5. The inlet passage 631 of the fluid transportation device 6 is in communication with the liquid storage member 5 through the intake passage 6a. The outlet passage 632 of the fluid transportation device 6 is in communication with the inlet 441 of the liquid conduit 44 of the atomizing member 4 through the outtake passage 6b and the liquid intake pipe 6c. Hence, the cigarette liquid can be transferred by the fluid transportation device 6 to the liquid conduit 44. After being transferred to the liquid conduit 44, the cigarette liquid infiltrates out of the liquid conduit 44 by the through holes 442. When the fluid transportation device 6 is powered and controlled by the control module 22, the fluid transportation device 6 transfers the cigarette quid out from the liquid storage member 5 at a fixed amount, and the fluid transportation device 6 is acting as a switch that controls transportation of the cigarette liquid from the liquid storage member 5 to the liquid conduit 44. Since the fluid transportation device 6 maintains transferring the cigarette liquid at a consistent pressure, the cigarette liquid uniformly infiltrates out of the liquid conduit 44 through the plural through holes 442 to generate uniform droplets. The transportation of the cigarette liquid is controlled to stop once the droplets of the cigarette liquid on the outer surface of the liquid conduit 44 have reached a saturation state. In other words, the cooperation of the fluid transportation device 6 and the atomizing member 4 establishes a controllable switch element which precisely controls the amount of the cigarette liquid infiltrated out of the liquid conduit 44 in the atomizing member 4. Consequently, the problems in prior art such as the bad taste of the atomized vapor caused by non-uniform droplets of the cigarette liquid, and leakage of the cigarette liquid, are improved and solved in the present disclosure.

The operations of the electronic cigarette will be described as follows. When the user inhales by the opening 92 of the mouthpiece 9, an airflow is generated in the electronic cigarette. At this moment, the sensing unit 3 enables the electric circuit of the electronic cigarette to activate the heater module 23 to start heating. When the user stops inhaling by the opening 92 of the mouthpiece 9, the airflow stops and the sensing unit 3 shuts down the electric circuit of the electronic cigarette to stop the heater module 23. Furthermore, the present disclosure combines the fluid transportation device 6 and the atomizing member 4 to establish a controllable switch, achieving precise control of an amount of the cigarette liquid that infiltrates out of the liquid conduit 44 of the atomizing member 4 after being transferred by the fluid transportation device 6 from the liquid storage member 5. When the user inhales by the opening 92 of the mouthpiece 9, the power supply device 2 powers the heater module 23 to activate the electric heater 41 to start heating. Meanwhile, the power supply device 2 controls the cigarette liquid to be transferred at a fixed amount to the electric heater 41, so as to generate the atomized vapor for being inhaled by the user through the mouthpiece 9. Moreover, while the user is inhaling by the opening 92 of the mouthpiece 9, since the air pressure sensor 32 keeps monitoring the magnitude of the pressure of the airflow, the air pressure sensor 32 transmits an adjusting signal to the control module 22 according to the result of detecting the pressure of the airflow. Then, according to the adjusting signal, the control module 22 adjusts a first control signal transmitted from the control module 22 to the heater module 23, and also adjusts a second control signal transmitted from the control module 22 to the fluid transportation device 6. Consequently, the driving power of the heater module 23 and the driving frequency of the fluid transportation device 6 are adjusted, so that the speed of atomizing the cigarette liquid and the speed of providing cigarette liquid are changed to be corresponding to intensity of inhalation of the user. Therefore, the user is able to not only inhale a great amount of the atomized vapor in a short period of time, but also inhale the atomized vapor in consistent amount and concentration in each breath.

From the above descriptions, the present disclosure provides the electronic cigarette in which the fluid transportation device is combined with the liquid conduit of the atomizing member to establish the controllable switch element. The amount of the cigarette liquid transferred to the atomizing member is precisely controlled by the controllable switch element. The electronic cigarette includes the sensing unit, which includes an airflow sensor and an air pressure sensor. The air pressure sensor detects the pressure of the airflow, and adjusts an adjusting signal according to the magnitude of the pressure of the airflow. The adjusting signal is transmitted from the air pressure sensor to the control module. According to the adjusting signal, the control module adjusts the control signals transmitted from the control module to the heater module and the fluid transportation device, so that the driving frequency of the fluid transportation device and the driving power of the heater module are correspondingly changed according to the control signals, by which the speed of atomizing the cigarette liquid and the speed of providing the cigarette liquid are adjusted. Moreover, the fluid transportation device can transfer the cigarette liquid with no backflow. As a result, the problems in the conventional electronic cigarette such as bad taste caused by non-uniform droplets and vapor as well as leakage of the cigarette liquid are solved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic cigarette, comprising:
a casing having an air intake;
a mouthpiece closing an end of the casing, the mouthpiece having an opening;
a sensing unit disposed within the casing and in air communication with the mouthpiece, the sensing unit being configured to sense an airflow and to enable or disable the electronic cigarette;
an atomizing member disposed within the casing and being vertical to an inner wall of the casing and adjacent to the sensing unit, the atomizing member comprising an electric heater and a liquid conduit, the liquid conduit having an inlet on an end thereof and having plural through holes thereon, the electric heater being sleeved on the liquid conduit;
a liquid storage member disposed within the casing to store a cigarette liquid;
a fluid transportation device disposed within the casing under the liquid storage member, the fluid transportation device comprising an intake passage and an outtake passage, the intake passage being in communication with the liquid storage member, the outtake passage being in communication with the inlet of the liquid conduit of the atomizing member; and
a power supply device electrically connected with the sensing unit, the atomizing member and the fluid transportation device to provide driving power and a control signal thereto;
wherein when the sensing unit senses the airflow, the sensing unit sends an enabling signal to the power supply device, and the power supply device accordingly enables the fluid transportation device, such that the cigarette liquid in the liquid storage member is guided out through the intake passage and transferred to the liquid conduit through the outtake passage, after which the cigarette liquid infiltrates out of the liquid conduit through the plural through holes, so that the cigarette liquid is transferred to the electric heater of the atomizing member at a fixed amount to generate an atomized vapor for being inhaled by the user through the opening of the mouthpiece, wherein when the sensing unit senses a stop of the airflow, the sensing unit stops sending the enabling signal to the power supply device, such that the fluid transportation device stops transferring the cigarette liquid and the electronic cigarette stops operating.

2. The electronic cigarette according to claim 1, wherein the casing is assembled by a first casing and a second casing oppositely connected to each other, wherein the power supply device is disposed within the first casing, and the sensing unit, the liquid storage member, the fluid transportation device and the atomizing member are disposed within the second casing.

3. The electronic cigarette according to claim 1, further comprising a bracket disposed within the casing and connected to the inner wall of the casing for supporting the atomizing member.

4. The electronic cigarette according to claim 1, wherein the outtake passage is in communication with the inlet of the liquid conduit of the atomizing member through a liquid intake pipe.

5. The electronic cigarette according to claim 1, wherein the power supply device comprises a power module, a control module, a heater module and a light emitting diode.

6. The electronic cigarette according to claim 5, wherein the power module of the power supply device is a rechargeable battery for providing driving power to the control module, the heater module, the sensing unit and the fluid transportation device.

7. The electronic cigarette according to claim 5, wherein the power module of the power supply device is a disposable battery for providing driving power to the control module, the heater module, the sensing unit and the fluid transportation device.

8. The electronic cigarette according to claim 5, wherein the control module of the power supply device is operable to transmit a first control signal to the heater module and a second control signal to the fluid transportation device, the control module provides driving power to the fluid transportation device, and the heater module of the power supply device provides electric energy to the electric heater of the atomizing member.

9. The electronic cigarette according to claim 5, wherein the light emitting diode of the power supply device is disposed on an end of the casing and controlled by the control module to be turned on or turned off for providing a prompt signal to indicate an operating condition of the electronic cigarette or to indicate an inhalation intensity of the atomized vapor.

10. The electronic cigarette according to claim 1, wherein the sensing unit comprises an airflow sensor and an air pressure sensor, the airflow sensor detects the airflow and accordingly enables or disables the electronic cigarette, and the air pressure sensor detects the pressure of the airflow and accordingly adjusts an adjusting signal transmitted therefrom to the power supply device to adjust the control signal provided from the power supply device so that a driving frequency of the fluid transportation device and the driving power of the heater module are changed by which a speed of providing the cigarette liquid and a speed of atomizing the cigarette liquid are changed.

11. The electronic cigarette according to claim 1, wherein the liquid conduit of the atomizing member is made of a stainless steel material.

12. The electronic cigarette according to claim 1, wherein the liquid conduit of the atomizing member is made of a heat-resistant material.

13. The electronic cigarette according to claim 1, wherein the mouthpiece further comprises a filter closing a junction of the mouthpiece and the casing to block the cigarette liquid that is incompletely atomized from inhalation by the user.

14. The electronic cigarette according to claim 1, wherein the fluid transportation device comprises:
a valve body comprising an inlet passage, an outlet passage, a first surface and a second surface, wherein the inlet passage and the outlet passage run through the first surface and the second surface, an inlet opening is formed in the second surface and in communication with the inlet passage, and an outlet opening is formed in the second surface and in communication with the outlet passage;
a valve membrane comprising two valve plates with the same thickness, plural extension parts arranged around the valve plates for elastically supporting the valve plates, and plural hollow parts arranged between each two adjacent extension parts;
a valve chamber seat comprising a third surface, a fourth surface, an inlet valve channel, an outlet valve channel and a pressure chamber, wherein the inlet valve channel and the outlet valve channel run through the third surface and the fourth surface, the two valve plates are supported by the inlet valve channel and the outlet valve channel, the pressure chamber is concavely formed on the fourth surface, and the pressure chamber is in communication with the inlet valve channel and the outlet valve channel; and
an actuator, wherein the pressure chamber of the valve chamber seat is covered and sealed by the actuator,
wherein the valve body, the valve membrane, the valve chamber seat and the actuator are sequentially assembled with each other, the actuator drives the inlet passage to suck the cigarette liquid from the intake passage, and the outlet passage transfers the cigarette liquid to the outtake passage.

15. The electronic cigarette according to claim 14, wherein the fluid transportation device comprises:
a valve cover comprising a first opening and a second opening; and
an outer sleeve comprising an inner wall, an accommodation space surrounded by the inner wall, and an annular protrusion structure formed on the bottom of the inner wall, wherein the valve body, the valve membrane, the valve chamber seat and the actuator are corresponding to each other and sequentially stacked and accommodated within the accommodation space and supported by the annular protrusion structure, wherein the inlet passage and the outlet passage of the valve body are respectively penetrating through the first opening and the second opening of the valve cover.

16. The electronic cigarette according to claim 15, wherein plural recesses are formed on the second surface of the valve body, and plural posts are formed on the third surface of the valve chamber seat, wherein the plural posts are engaged with the corresponding recesses, so that the valve chamber seat is fixed on the valve body.

17. The electronic cigarette according to claim 16, wherein the valve membrane is disposed between the valve body and the valve chamber seat, and the valve membrane comprises plural positioning holes corresponding to the plural posts, wherein the plural posts are penetrating through the corresponding positioning holes to position the valve membrane.

18. The electronic cigarette according to claim 17, wherein a first groove is formed on the second surface and arranged around the inlet opening, a second groove is formed on the second surface and arranged around the outlet opening, a third groove is formed on the third surface and arranged around the inlet valve channel, and a fourth groove is formed on the third surface and arranged around the outlet valve channel, wherein the fluid transportation device further comprises plural sealing rings respectively trapped in the first groove, the second groove, the third groove and the fourth groove.

19. The electronic cigarette according to claim 18, wherein a first protrusion block is formed on the second surface of the valve body and disposed around the inlet opening, and a second protrusion block is formed on the third surface and disposed around the outlet valve channel, wherein the first protrusion block and the second protrusion block respectively make the two valve plates attached thereon to generate pre-forces for a sealing effect and preventing backflow of the cigarette liquid.

20. The electronic cigarette according to claim 19, wherein the actuator comprises a vibration plate and a piezoelectric element, wherein the piezoelectric element is attached on a surface of the vibration plate, the piezoelectric element is subjected to a deformation in response to an applied voltage, and the vibration plate of the actuator is assembled with the fourth surface of the valve chamber seat to cover and seal the pressure chamber.
